(19) United States
(12) Patent Application Publication
(10) Pub. No.: US 2008/0201871 A1
(43) Pub. Date: Aug. 28, 2008

(54) ANTIMICROBIAL COLORANTS

(75) Inventors: Gang Sun, Davis, CA (US); Junshu Liu, Davis, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of California, Oakland, CA (US)

(21) Appl. No.: 11/870,391

(22) Filed: Oct. 10, 2007

Related U.S. Application Data
(63) Continuation of application No. PCT/US07/77709, filed on Sep. 6, 2007.
Application No. PCT/US07/77709 is a continuation-in-part of application No. 10/804,354, filed on Mar. 18, 2004, now abandoned.
(60) Provisional application No. 60/824,721, filed on Sep. 6, 2006.
(60) Provisional application No. 60/456,620, filed on Mar. 19, 2003.

(30) Foreign Application Priority Data
Sep. 6, 2007 (US) PCT/US07/77709

(51) Int. Cl. D06P 3/79; C09B 1/16; D06P 3/00; C09B 1/02; A01N 35/06

(52) U.S. Cl. 8/508; 552/238; 514/680; 8/514; 8/513; 8/675

(57) ABSTRACT

Quaternary ammonium salts were incorporated into anthraquinone dyes via a stable linkage. The structure of the antimicrobial colorants were characterized by Fourier Transform Infrared (FTIR), Nuclear Magnetic Resonance (NMR) and UV-vis spectrometry. The dyes demonstrated excellent antimicrobial ability against both gram-negative and gram-positive bacteria in aqueous solution, as indicated by very low minimum inhibitory concentration (MIC). The colorants showed excellent stability in water under light, continuous heating as well as acidic and alkaline conditions.

### CROSS-REFERENCES TO RELATED APPLICATIONS

The present application claims priority to U.S. Provisional Application No. 60/824,721, filed Sep. 6, 2006, and is a CIP application of U.S. application Ser. No. 10/804,354, pending, which application claims priority to U.S. Provisional Application No. 60/456,620, filed Mar. 19, 2003, the teaching each of which is hereby incorporated by reference in their entireties for all purposes.

### BACKGROUND OF THE INVENTION

Many cationic dyes possess antimicrobial functions and have been widely applied in topical cleaning, clinical use, preservatives for food and the fishery industries since the 19th century (see, Balabanova, M., Popova L. et al., Clinics in Dermatology, 21:2 (2003); Yoshikawa, K., Inada, K. et al., 21(88):123 (1970); Fung, D. Y. C. and Miller, R. D., Applied Microbiology, 25(5):793 (1973)). The most commonly used antimicrobial colorants are derivatives of triphenylmethane dyes such as gentian violet, brilliant green and malachite green, which have poor light stability and tend to be decolorized by bacteria (see, Jones, J. J. and Falkinham, J. III, Antimicrobial Agent and Chemotherapy, 47(7):2323 (2003)). Also, a high concentration of these dyes is needed to achieve the expected functions due to high minimum inhibition concentration (MIC) of the dyes, while a high concentration of the dyes creates concerns of staining. In recent decades, scores of new antimicrobial agents, especially quaternary ammonium compounds have been invented to substitute these antimicrobial dyes.

Quaternary ammonium salts (QAS) are cationic surface active compounds that can provide combined effects of disinfection, surface-activation, and antistatic properties (see, Patrauchan, M. A. and Oriel, P. J., Journal of Applied Microbiology, 94:266 (2003)). Because they destroy microbes by a physical penetration mechanism (see, Russell, A. D. and Russell, N. J., Symposium of the Society for General Microbiology, 53:327 (1995)), QAS are relatively mild in action and effective against a broad spectrum of microorganisms such as bacteria (both Gram-positive and Gram-negative), fungi and enveloped viruses. So far, QAS have been extensively employed as disinfectants in many fields such as chemical formulations, personal care products, surface cleaning spray, and dental products. (see, Russell, A. D. and Russell, N. J., Symposium of the Society for General Microbiology, 53:327 (1995); Broughton, R. M. Jr., Worley, S. D. et al., International Nonwovens Technical Conference, 737-47 (2001); Sun, G., ACS Symposium Series, 792:243 (2001)). QAS are also applied in resins, textiles and other polymers to incorporate antimicrobial functions by chemical grafting or finishing (see, Destais, N., Ades, D. et al., Polymer bulletin, 44:401 (2000); Kenawy, E. R. and Mahmoud, Y. A. G., Macromol Biosci, 3(2):107 (2003); Kim, Y. H. and Sun, G., Textile Research Journal, 72:1052 (2002); Zhu, P. and Sun, G., J Appl Polym Sci, 93:1037 (2004); Son, Y. A. and Sun, G., J Appl Polym Sci, 90:2194 (2003); Cai, Z. and Sun, G., J Appl Polym Sci, 94:243 (2004); Zhao, T. and Sun, G., J Appl Polym Sci., 103:482 (2007); Qin, C., Xiao, Q. et al., Int J Biol Macromol 34:121 (2004)). Efforts have been made to incorporate antimicrobial functions to textiles using N-halamine structures (see, Sun, Y. and Sun, G., Journal of Applied Polymer Science, 84:1592-1599 (2002); Liang, J., Chen, Y. et al., Biomaterials, 27:2495-2501 (2006)).

Despite the advances of N-halamine structures, and in view of the foregoing, what is needed in the art are dyes incorporated with QAS biocidal groups for polymers, textiles and fibers. The present invention satisfies these and other needs.

### BRIEF SUMMARY OF THE INVENTION

The present invention provides novel antimicrobial cationic dyes comprising a quaternary ammonium salt (QAS) group covalently attached to an aminoanthraquinioid dye optionally via a linker. The dyes are particularly useful for imparting a functional property to a polymer, such as an antimicrobial functionality, and for simultaneously dyeing and finishing a polymer (e.g., textile).

As such, the present invention provides a compound having formula I:

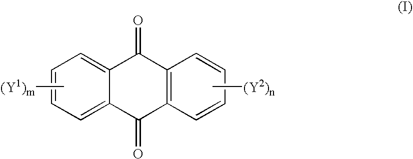

wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

In certain preferred embodiments, the present invention provides a compound of formula Ib:

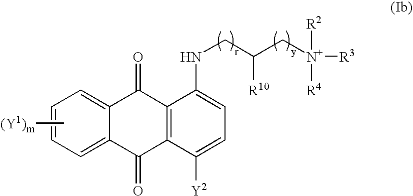

wherein:
Y² is —H or —N(R¹)-L-N⁺(R²)(R³)(R⁴).X⁻;
R² and R³ are each independently selected from an optionally substituted C₁-C₄ alkyl groups;
R⁴ is an optionally substituted C₄-C₁₈ alkyl group;
R¹⁰ is a member selected from the group of hydrogen, hydroxyl, an optionally substituted alkyl, an optionally substituted alkoxy, an optionally amino, an optionally substituted aryl, and an optionally substituted thiol.
r and y are each independently 0 to 4; and
X is a counter anion.

In still another embodiment, the present invention provides an antimicrobial composition, comprising:
(a) a polymer, wherein the polymer is a member selected from the group of a textile, a plastic, rubber, paint, a surface coating, a spray, an adhesive, and a combination thereof; and
(b) a compound having formula I:

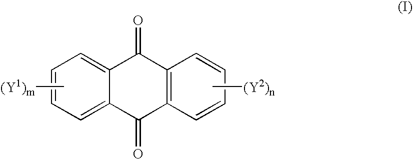

wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

In still yet another embodiment, the present invention provides a method for simultaneously dyeing and finishing a polymer, comprising:
immersing the polymer in an aqueous treating solution which comprises a compound having formula I:

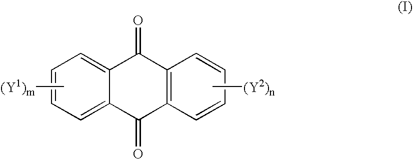

wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

In still another embodiment, the present invention provides a method for preparing a colorant, comprising:
contacting a compound of formula II:

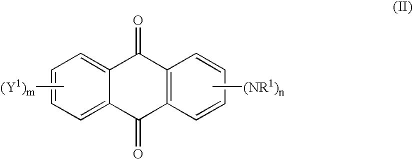

with a compound of formula E-L-X under conditions sufficient to form a compound of formula III:

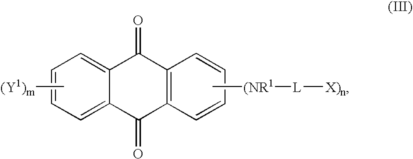

wherein:
each Y¹, which may be the same or different, is independently selected from a quaternary ammonium salt group and a substituent group;
R¹ is a member selected from the group consisting of hydrogen, an optionally substituted alkyl group, and an amino protecting group;
E is an electrophic group or a carbon capable of reacting with an amino group to form a nitrogen-carbon bond;
L is a bond or a linker selected from the group consisting of alkylene, heteroalkylene, cycloalkylene, cycloalkylalkyllene, arakylene, arylene, heteroarylene, heteroaralkylene, alkenylene, substituted alkylene and alknylene;
X is a halide;
m is an integer from 0 to 4; and
n is an integer from 1 to 4.

In yet another embodiment, the present invention provides a method for preparing an antimicrobial colorant, comprising:
contacting a compound of formula III:

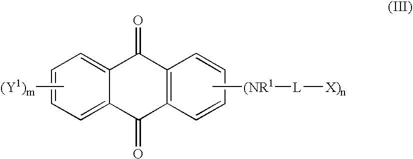

with a tertiary amine having the formula: N(R²)(R³)(R⁴) under conditions sufficient to form a quaternary ammonium salt of formula I,
   wherein:
R¹ is a member selected from the group consisting of hydrogen, an optionally substituted alkyl group, and an amino protecting group;
each of R², R³, and R⁴ is independently selected from the group consisting of hydrogen, an optionally substituted alkyl, an optionally substituted aryl, an optionally substituted aralkyl, an optionally substituted cycloalkyl, and cycloalkylalkyl;
L is a bond or a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, and an optionally substituted alknylene; and
X is a counter anion.

There are a myriad of applications for the compounds, i.e., the QAS-dyes, of the present invention. For example, polymers, e.g., textile materials, can be treated with the QAS-dyes to provide a biocidal protective coating on the polymers effective against a variety of microorganisms. The treated polymers are suitable for use as clothing in the medical field as well as in related healthcare and hygiene areas. Treated polymers of the present invention can be fabricated into disposable or reusable textile materials.

The microbiocidal properties of the textiles of the present invention can be advantageously used for women's wear, underwear, socks, and other hygienic purposes such as upholsteries. In addition, the microbiocidal properties can be imparted to carpeting materials to create odor-free and/or germ-free carpets. Moreover, all germ-free environments, such as those required in biotechnology and the pharmaceutical industry, can benefit from the use of the microbiocidal textiles of the present invention to prevent any contamination from air, liquid, and/or solid media.

Other features, objects and advantages of the invention and its preferred embodiments will become apparent from the detailed description which follows.

### BRIEF DESCRIPTION OF THE DRAWINGS

FIG. 1 illustrates one embodiment of a synthesis route of antimicrobial colorants (wherein the alkylene chain length varies) of the present invention.

FIG. 2 illustrates a FTIR spectra of certain embodiments of antimicrobial colorants of the present invention.

FIG. 3 illustrates a ¹H NMR spectrum of one compound of the present invention.

FIG. 4 illustrates a ¹H ¹H COSY spectrum of one compound of the present invention.

FIG. 5 illustrates a UV vis absorbance spectra (concentration=100 ppm) of compounds of the present invention.

FIG. 6 illustrates a UV vis spectra of compounds of the present invention.

### DETAILED DESCRIPTION OF THE INVENTION

### I. Definitions

The term “alkyl” includes a saturated linear monovalent hydrocarbon radical or a saturated branched monovalent hydrocarbon radical containing from 1 to 20 carbon atoms. Preferably, the alkyl radical contains from 1 to 4 carbon atoms (i.e., C ₁-C₄ alkyl) or from 4 to 18 carbons atoms (i. e., C₄-C₁₈ alkyl). Exemplary alkyl groups include, but are not limited to, methyl, ethyl, n-propyl, 2-propyl, butyl, iso-butyl, sec-butyl, tert-butyl, pentyl, iso-amyl, hexyl, heptyl, octyl, nonyl, decyl, undecyl, dodecyl, and the like.

The term “alkylene” includes a saturated linear divalent hydrocarbon radical or a saturated branched divalent hydrocarbon radical containing from 1 to 20 carbon atoms. Preferably, the alkylene radical contains from 1 to 12 carbon atoms (i.e., C₁-C₁₂ alkylene). Exemplary alkylene groups include, but are not limited to, methylene, ethylene, propylene, butylene, pentylene, hexylene, heptylene, octylene, nonylene, decylene, undecylene, dodecylene, and the like.

The term “cycloalkyl” includes a cyclic alkyl radical containing from 3 to 8, preferably from 3 to 6, carbon atoms. Exemplary cycloalkyl groups include, but are not limited to, cyclopropyl, cyclobutyl, cyclopentyl, cyclohexyl, and the like.

The term “cycloalkylene” includes a cyclic carbocycle radical containing from 4 to 8, preferably 5 or 6, carbon atoms and one or more double bonds. Exemplary cycloalkylene groups include, but are not limited to, cyclopentylene, cyclohexylene, cyclopentadienylene, and the like.

The term “aryl” includes a carbocyclic aromatic radical selected from the group consisting of phenyl, naphthyl, indenyl, indanyl, azulenyl, fluorenyl, anthracenyl, and the like; or a heterocyclic aromatic radical selected from the group consisting of furyl, thienyl, pyridyl, pyrrolyl, oxazolyly, thiazolyl, imidazolyl, pyrazolyl, 2-pyrazolinyl, pyrazolidinyl, isoxazolyl, isothiazolyl, 1,2,3-oxadiazolyl, 1,2,3-triazolyl, 1,3,4-thiadiazolyl, pyridazinyl, pyrimidinyl, pyrazinyl, 1,3,5-triazinyl, 1,3,5-trithianyl, indolizinyl, indolyl, isoindolyl, 3H-indolyl, indolinyl, benzo[b]furanyl, 2,3-dihydrobenzofuranyl, benzo[b]thiophenyl, 1H-indazolyl, benzimidazolyl, benzthiazolyl, purinyl, 4H-quinolizinyl, quinolinyl, isoquinolinyl, cinnolinyl, phthalazinyl, quinazolinyl, quinoxalinyl, 1,8-naphthyridinyl, pteridinyl, carbazolyl, acridinyl, phenazinyl, phenothiazinyl, phenoxazinyl, and the like. The aryl group can also have from one to five substituents selected from the group consisting of hydrogen, halogen, hydroxyl, amino, nitro, trifluoromethyl, trifluoromethoxy, alkyl, alkylene, alkynyl, 1,2-dioxymethylene, 1,2-dioxyethylene, alkoxy, alkenoxy, alkynoxy, alkylamino, alkenylamino or alkynylamino, alkylcarbonyloxy, aliphatic or aromatic acyl, alkylcarbonylamino, alkoxycarbonylamino, alkylsulfonylamino, N-alkyl, N,N-dialkyl urea, and the like.

The term “alkoxyl” includes an alkyl ether radical containing from 1 to 20 carbon atoms. Exemplary alkoxyl groups include, but are not limited to, methoxyl, ethoxyl, n-propoxyl, iso-propoxyl, n-butoxyl, iso-butoxyl, sec-butoxyl, tert-butoxyl, and the like.

The term “alkylamino” includes a mono- or di-alkyl-substituted amino radical (i.e., a radical having the formula: alkyl-NH— or (alkyl)₂-N—), wherein the term “alkyl” is as defined above. Exemplary alkylamino groups include, but are not limited to, methylamino, ethylamino, propylamino, iso-propylamino, t-butylamino, N,N-diethylamino, and the like.

The term “aralkyl” includes an aryl radical, as defined herein, attached to an alkyl radical, as defined herein.

The term “amino protecting group” includes a group which will decrease the reactivity of amine group, such as by converting it to an amide or a carbamate. The carbonyl group effectively withdraws electron density from the nitrogen and renders it unreactive. Formation of N-acyl derivatives such as benzyloxycarbonyl (Z or Cbz), t-butoxycarbonyl (t-BOC), 9-fluorenylmethoxycarbonyl (Fmoc) and phthalimides (Pht) are a few of the suitable amino protecting groups. Those of skill in the art will know of other amino protecting groups suitable for use in the present invention.

The term “cycloalkylalkyl” includes a cycloalkyl radical, as defined herein, attached to an alkyl radical, as defined herein.

The term “optionally substituted” includes both the “unsubstituted” and “substituted” substituent. For example, “optionally substituted alkyl” includes “unsubstituted alkyl” and “substituted alkyl,” the latter of which refers to moieties having substituents replacing one or more hydrogens on one or more carbons. Such substituents can include, for example, alkyl groups, alkynyl groups, halogens, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The term “heteroatom” includes any atom that is not carbon or hydrogen. Exemplary heteroatoms include, but are not limited to, nitrogen, oxygen, sulfur, phosphorus, boron, and the like.

The term “functional finishing dye” includes a dye containing at least one functional finishing group covalently attached to the dye via a chemical linkage.

The term “functional finishing group” includes a moiety that is present in a functional finishing dye which imparts a particular functional property to the dye-treated polymer.

The term “functional property” or “functionality,” as used herein, includes a particular non-inherent and/or enhanced physical property of the polymer due to the presence of a functional finishing group. Exemplary functional properties include, but are not limited to, antimicrobial, anti-static, softening, water-repellent, fire-resistant, soil-repellent, anti-UV, and anti-chemical properties, as well as a combination of two or more properties thereof. Antimicrobial functionality is preferred.

“Leaving group” has the meaning conventionally associated with it in synthetic organic chemistry, i.e., an atom or a group capable of being displaced by a nucleophile, and includes halo (such as chloro, bromo, and iodo), alkanesulfonyloxy, arenesulfonyloxy, alkylcarbonyloxy (e.g., acetoxy), arylcarbonyloxy, mesyloxy, tosyloxy, trifluoromethanesulfonyloxy, aryloxy (e.g., 2,4-dinitrophenoxy), methoxy, N,O-dimethylhydroxylamino, and the like.

The terms “antimicrobial,” “microbicidal,” or “biocidal” as used herein, includes the ability to kill at least some types of microorganisms, or to inhibit the growth or reproduction of at least some types of microorganisms. The polymers prepared in accordance with the present invention have microbicidal (i.e., antimicrobial) activity against a broad spectrum of pathogenic microorganisms. For example, the textiles, polymers and fibers have microbicidal activity against representative gram-positive (e.g., Staphylococcus aureus) and gram-negative (e.g., Escherichia coli) bacteria.

The term “quaternary ammonium salt group” includes an amphipathic molecule that contains both a hydrophilic portion and a hydrophobic portion and is covalently attached to a dye. Preferably, the quaternary ammonium salt group has the formula:

—N(R³)-L-N⁺(R⁴)(R⁵)(R⁶).X⁻, IA

wherein:
R³ is a member selected from the group consisting of hydrogen, an optionally substituted alkyl group, and an amino protecting group;

each of R⁴, R⁵, and R⁶ is independently selected from the group consisting of hydrogen, an optionally substituted alkyl, an optionally substituted aryl, an optionally substituted aralkyl, an optionally substituted cycloalkyl, and an optionally substituted cycloalkylalkyl;
L is a linker comprising a 1-12 carbon atom chain; and
X is a counter anion.

As used herein, the term “treating,” “contacting,” or “reacting” includes adding or mixing two or more reagents under appropriate conditions to produce the indicated and/or the desired product. It should be appreciated that the reaction which produces the indicated and/or the desired product may not necessarily result directly from the combination of two reagents which were initially added, i.e., there may be one or more intermediates which are produced in the mixture which ultimately leads to the formation of the indicated and/or the desired product.

### II. General

In certain aspects, the present invention provides antimicrobial cationic colorants with high potency and good hydrolytic stability under light, heat, and pH conditions. In one aspect, anthraquinone structures, which have excellent light and heat stability, are chemically connected to biocidal QAS with different hydrocarbon chain lengths. QAS with the chain length of about C₂ to about C₂₆, preferably about C₈ to about C₁₈ (e.g., C₈, C₉, C₁₀, C₁₁, C₁₂, C₁₃, C₁₄, C₁₅, C₁₆, C₁₇, C₁₈) show good antimicrobial properties.

### III. Compounds

The antimicrobial compounds of the present invention comprise a functional finishing group (e.g., QAS) covalently attached to a dye moiety optionally via a linker. Suitable dyes include, without limitation, cationic dyes such as basic red 9, basic blue 9, basic blue 69, basic blue 22, basic orange 14, basic green 1, basic yellow 1, basic violet 2, basic brown 1, and other basic dyes; acid dyes such as an Acid Black dye, an Acid Blue dye, an Acid Orange dye, an Acid Red dye, an Acid Violet dye, and an Acid Yellow dye; disperse dyes such as Disperse Blue 1, Disperse Yellow 7 and Disperse Yellow 9; and combinations thereof. Direct dyes and reactive dyes are also suitable for use in the present invention. In a particularly preferred embodiment, the dye is an aminoanthraquinioid dye such as 1-aminoanthraquinone and 1,4-diaminoanthraquinone. See, for example, U.S. patent application Ser. No. 10/804,354 filed on Mar. 18, 2004, having U.S. Patent Publication No. US2005/0011012 and incorporated herein by reference in its entirety and for all purposes.

Suitable functional finishing groups are also well known to those skilled in the art. The functional finishing group imparts a particular non-inherent and/or enhanced physical property, i. e., a functional property, to the polymer, textile or fiber. Exemplary functional properties include, but are not limited to, antimicrobial, anti-static, softening, water-repellent, fire-resistant, soil-repellent, anti-UV, and anti-chemical properties, as well as a combination of two or more properties thereof. In a particularly preferred embodiment, the functional finishing group is a quaternary ammonium salt group that imparts antimicrobial and/or anti-static properties to the polymer, textiles and fibers.

By covalently linking dyes to functional finishing groups, a wide variety of functional finishing dyes can be prepared in accordance with the present invention. Such functional finishing dyes allow polymers, textile materials and fibers to be dyed and functionalized simultaneously in a single treatment process, thereby reducing the overall cost and time for producing dyed and functionalized polymers.

The presence of a linker between the dye and the functional finishing group can be optional depending on the reactive groups that are present on the dye and the functional finishing group. For example, if complementary reactive groups are present on the dye and the functional finishing group, they can be covalently attached without the need for any additional linker. However, if the reactive groups that are present on the dye and the functional finishing group are not complementary reactive groups, one of the reactive groups can be converted to a complementary reactive group, or a linker having appropriate complementary reactive groups can be used to covalently link the dye and the functional finishing group. In a preferred embodiment, the linker comprises an optionally substituted 1-12 carbon atom chain which is optionally interrupted with one or more heteroatoms. Suitable carbon atom chains include, without limitation, an optionally substituted alkylene group, a —C(O)R group, wherein R is an optionally substituted alkylene group, and an alkylamino group. Preferably, the linker is stable to hydrolysis.

In one aspect, the antimicrobial colorant is a QAS-aminoanthraquinioid dye conjugate, i.e., QAS-dye, having the formula I:

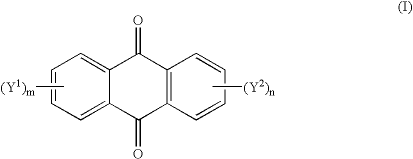

wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

In one embodiment, the quaternary ammonium salt group has formula Ia:

—N(R¹)-L-N⁺(R²)(R³)(R⁴).X⁻, (Ia)

wherein:
R¹ is a member selected from the group consisting of hydrogen, an optionally substituted alkyl group, and an amino protecting group;
each of R², R³, and R⁴ is independently selected from the group consisting of hydrogen, optionally substituted alkyl, optionally substituted aryl, optionally substituted aralkyl, optionally substituted cycloalkyl, and optionally substituted cycloalkylalkyl;
L is a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, and an optionally substituted alknylene; and
X is a counter anion.

In a preferred embodiment, L is an optionally substituted C₁₋₆ alkylene, an optionally substituted C₁₋₆heteroalkylene or an optionally substituted C₇₋₁₀arakylene. More preferably, L is an optionally substituted C₁₋₄alkylene or an optionally substituted C₁₋₄heteroalkylene. In a most preferred embodiment, L is an optionally substituted C₁₋₄hydroxyalkylene.

In another embodiment, R² and R³ are each independently selected from an optionally substituted C₁-C₄ alkyl group, and R⁴ is an optionally substituted C₄-C₁₈ alkyl group. In a preferred embodiment, the R² and R³ groups are methyl groups, and R⁴ is an optionally substituted C₄-C₁₈ alkyl group. Suitable R⁴ groups include, for example, an optionally substituted butyl, an optionally substituted pentyl, an optionally substituted hexyl, an optionally substituted heptyl, an optionally substituted octyl, an optionally substituted nonyl, an optionally substituted decyl, an optionally substituted undecyl, an optionally substituted dodecyl and an optionally substituted hexadecyl groups. In a particularly preferred embodiment, the R⁴ group is an optionally substituted butyl, an optionally substituted octyl, an optionally substituted dodecyl or an optionally substituted hexadecyl group.

In yet another embodiment, X is independently selected from the group consisting of F⁻, Cl⁻, Br⁻, I⁻, and combinations thereof. In still yet another embodiment, the substituent group is independently selected from the group consisting of hydrogen, an optionally substituted alkyl, an optionally substituted aryl, an optionally substituted aralkyl, an optionally substituted cycloalkyl, an optionally substituted cycloalkylalkyl, an optionally substituted sulfonate, hydroxyl, an optionally substituted alkoxyl, an optionally substituted amino, and an optionally substituted alkylamino groups. In a further embodiment, m is 0.

In another aspect, the present invention provides a compound of formula Ib

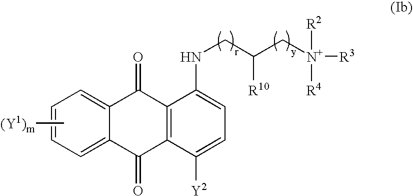

wherein:
each Y¹, which may be the same or different, is independently selected from a quaternary ammonium salt group and a substituent group;
Y² is —H or —N(R¹)-L-N⁺(R²)(R³)(R⁴).X⁻;
R¹ is a member selected from the group consisting of hydrogen, an optionally substituted alkyl, and an amino protecting group;
R² and R³ are each independently selected from an optionally substituted C₁-C₄ alkyl groups;
R⁴ is an optionally substituted C₄-C₁₈ alkyl group;
R¹⁰ is a member selected from the group consisting of hydrogen, hydroxyl, an optionally substituted alkyl, an optionally substituted alkoxy, an optionally amino, an optionally substituted aryl, and an optionally substituted thiol;
r and y are each independently 0 to 4;
m is 0 to 4; and
X is a counter anion.

In certain instances, r is 0, 1, 2, 3 or 4. In certain instances, y is 0, 1, 2, 3 or 4. In certain preferred aspects, m is 0; Y² is —H; R¹⁰ is hydroxyl; r is 1 and y is 1.

In certain preferred aspects, compounds of formula Ib have the following structure:

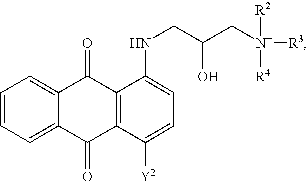

wherein:
Y¹ is —H or —N(R¹)-L-N⁺(R²)(R³)(R⁴).X⁻;
R¹ is a member selected from the group consisting of hydrogen, an optionally substituted alkyl group, and an amino protecting group;
R² and R³ are each independently selected C₁-C₄ alkyl groups;
R⁴ is an optionally substituted C₄-C₁₈ alkyl group; and
X is a counter anion.

In another embodiment, r and y are 1 or 2. Within this group of compounds, a particularly preferred compounds of formula I have the following structures:

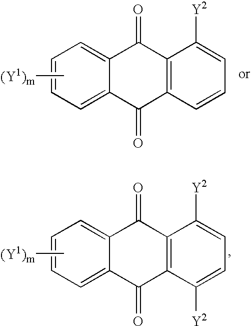

wherein each Y¹, which may be the same or different, and each Y², which may be the same or different, and m are as defined above.

In an especially preferred embodiment, the compound of formula I has the following structure:

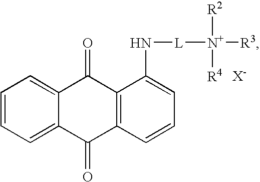

wherein:
R² and R³ are each independently selected an optionally substituted C₁-C₄ alkyl groups;
R⁴ is a C₄-C₁₈ an optionally substituted alkyl group;
L is an optionally substituted C₁-C₁₂ alkylene group optionally interrupted with a heteroatom; an optionally substituted C₁₋₁₂heteroalkylene; or an optionally substituted —C(O)R⁵ group, wherein R⁵ is an optionally substituted C₁-C₁₂ alkylene group; and
X is a counter anion.

Preferably, L is an optionally substituted C₁₋₄alkylene. More preferably, L is an optionally substituted C₃alkylene, for example, 2-hyxdroxypropylene.

In certain aspects, other suitable substituted groups on the alkylene chain of L include, for example, alkyl groups, alkynyl groups, halogens, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

In one embodiment, R² and R³ are methyl groups. In a second embodiment, R⁴ is an octyl, a dodecyl or a hexadecyl group. In a third embodiment, L is a —CH₂ or a —C(O)CH₂—group. In a fourth embodiment, X is independently selected from the group consisting of F⁻, Cl⁻, Br⁻, I⁻, and combinations thereof.

In another preferred embodiment, the compound of formula IVb has the following structure:

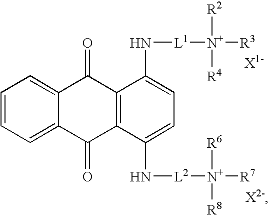

wherein
R², R³, R⁶, and R⁷ are each independently an optionally substituted C₁-C₄ alkyl group;
R⁴ and R⁸ are each independently an optionally substituted C₄-C₁₈ alkyl groups;
L¹ and L² are each independently selected from an optionally substituted C₁-C₁₂ alkylene group, which is optionally interrupted with a heteroatom, an optionally substituted C₁₋₁₂heteroalkylene or an optionally substituted —C(O)R⁹ group, wherein R⁹ is an optionally substituted C₁-C₁₂ alkylene group; and
each of X₁ and X₂ is an independently selected from a counter anion.

In one embodiment, R², R³, R⁶, and R⁷ are an optionally substituted methyl group. In a second embodiment, R⁴ and R⁸ are each independently selected from the group consisting of an optionally substituted butyl, an optionally substituted octyl, an optionally substituted dodecyl and an optionally substituted hexadecyl group. In a third embodiment, L¹ and L² are each independently selected —CH₂— or —C(O)CH₂— groups. In a fourth embodiment, X¹⁻ and X₂⁻ are each independently selected from the group consisting of F⁻, Cl⁻, Br⁻, I⁻, and combinations thereof.

### IV. Synthesis

The compounds of the present invention can be made using a variety of methods known by those of skill in the art, such as for example, solid-phase, solution-phase, and combinatorial synthesis. It should be appreciated that although the following schemes and figures for producing compounds of formula I often indicate exact structures, methods of the present invention apply widely to analogous compounds of formula I as well as to other dyes known to one skilled in the art given an appropriate consideration to protection and deprotection of reactive functional groups by methods standard to the art of organic chemistry. For example, in order to prevent unwanted side reactions, hydroxyl groups sometimes need to be converted to ethers or esters during chemical reactions at other sites in the molecule. The hydroxyl protecting group is then removed to provide the free hydroxyl group. Similarly, amino groups and carboxylic acid groups can be derivatized to protect against unwanted side reactions. Typical protecting groups, and methods for attaching and cleaving them, are described fully in, for example, T. W. Greene and P. G. M. Wuts, Protective Groups in Organic Synthesis, 3^{rd} edition, John Wiley & Sons, New York, 1999, and Harrison and Harrison et al., Compendium of Synthetic Organic Methods, Vols. 1-8 (John Wiley and Sons, 1971-1996), which are incorporated herein by reference in their entirety.

In certain aspect, the presence of a linker between the dye and the functional finishing group is optional depending on the reactive groups that are present on the dye and the functional finishing group. Some of the methods described above are described in U.S. patent application Ser. No. 10/804,354 filed on Mar. 18, 2004, having U.S. Patent Publication No. US2005/0011012 and incorporated herein by reference in its entirety and for all purposes.

Methods for preparing antimicrobial colorants will now be illustrated with respect to preparing compounds of formula I wherein Y¹ is a quaternary ammonium salt group. As shown in Scheme I below, an anthraquinone compound 1 having one or more amino functional groups is reacted with a linker compound 2 to produce a substituted aminoanthraquinone 3.

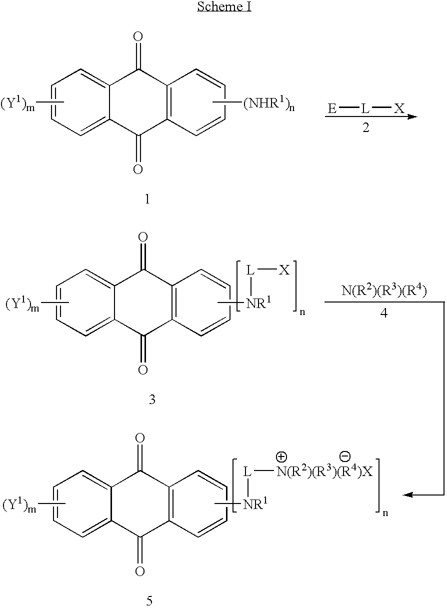

The linker compound 2 may comprise two different reactive functional groups such that one of the reactive functional group reacts preferentially with the amino group of the anthraquinone compound 1. For example, the linker compound 2 can comprise an activated acyl group, e.g., acyl halide, alkyl halide, epoxide, or anhydride, and a leaving group for a nucleophilic substitution reaction, or an electrophilic site for nucleophilic addition reactions. In this manner, the activated acyl group, i.e., E, reacts preferentially with the amino group. Suitable reaction conditions for coupling an amino group with an activated acyl group are well known to one skilled in the art and typically involve reacting the two groups at reduced temperature, e.g., 0° C. A base and/or a coupling catalyst can optionally be added to the reaction mixture to neutralize any acid that may be generated and/or to facilitate the coupling reaction, respectively. An acid can also be used to facilitate the nucleophilic addition reactions.

The substituted aminoanthraquinone 3, such as a disubstituted aminoanthroquinone can optionally be purified prior to reacting with a tri-substituted amine compound 4 to produce a quaternary ammonium salt substituted anthraquinone 5. Unlike the first coupling reaction which involves an acyl transfer reaction, this second coupling reaction typically involves a nucleophilic substitution reaction where the amino group of the tri-substituted amine compound 4 displaces the leaving group X on the substituted aminoanthraquinone 3. Suitable reaction conditions for a nucleophilic substitution reaction are known to one skilled in the art and often involve elevated reaction temperatures, i.e., >25° C. and preferably >50° C.

While the above reactions have been described in a particular order of producing the quaternary ammonium salt substituted anthraquinone 5, it should be appreciated that methods for producing such a compound are not limited to this particular order. For example, by selecting appropriate reactive groups E and X, the linking group 2 can be reacted first with the tri-substituted amine compound 4, and then the resulting product can be reacted with the anthraquinone compound 1.

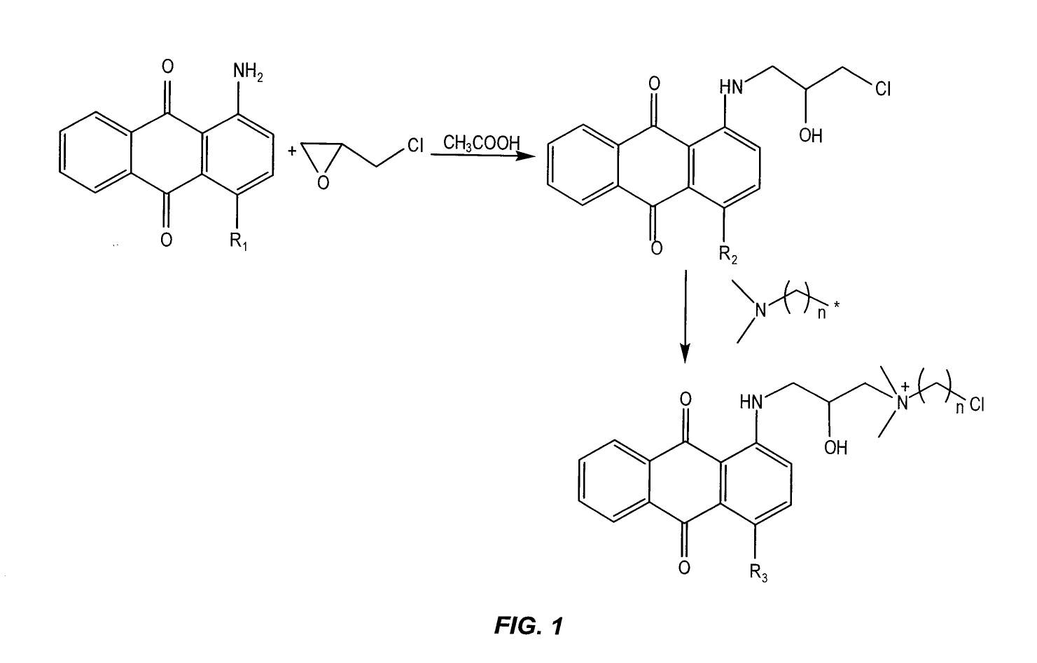

In one such method illustrated in FIG. 1, in no way intended to be limiting, the following method can be used. The following illustration is intended to be one particular synthetic strategy that can be employed in producing the functional finishing dyes of the present invention.

The first step of the synthesis involves, for example, alkylation of an amino group(s) on the anthraquinone scaffold with a chlorinated epoxide. As shown therein, the second step involves nucleophilic substitution with a tri-substituted amine compound to produce a quaternary ammonium salt substituted anthraquinone of the present invention.

As such, the present invention also provides methods for preparing a colorant, comprising:
contacting a compound of formula II:

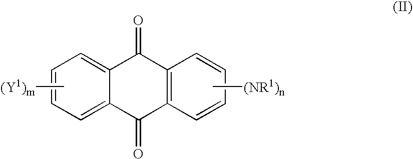

with a compound of formula E-L-X under conditions sufficient to form a compound of formula III:

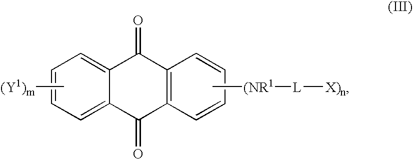

wherein:
each Y¹, which may be the same or different, is independently selected from a quaternary ammonium salt group and a substituent group;
R¹ is a member selected from the group consisting of hydrogen, an optionally substituted alkyl group, and an amino protecting group;
E is an electrophic group or a carbon capable of reacting with an amino group to form a nitrogen-carbon bond;
L is a bond or a linker selected from the group consisting of alkylene, heteroalkylene, cycloalkylene, cycloalkylalkyllene, arakylene, arylene, heteroarylene, heteroaralkylene, alkenylene, substituted alkylene and alknylene;
X is a halide;
m is an integer from 0 to 4; and
n is an integer from 1 to 4.

In certain other aspects, the present invention provides an antimicrobial colorant, comprising: contacting a compound of formula III:

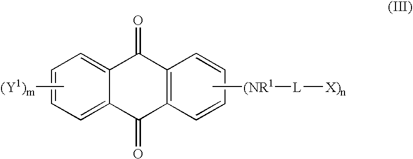

with a tertiary amine having the formula: N(R²)(R³)(R⁴) under conditions sufficient to form a quaternary ammonium salt of formula I,

wherein:
R¹ is a member selected from the group consisting of hydrogen, an optionally substituted alkyl group, and an amino protecting group;
each of R², R³, and R⁴ is independently selected from the group consisting of hydrogen, an optionally substituted alkyl, an optionally substituted aryl, an optionally substituted aralkyl, an optionally substituted cycloalkyl, and cycloalkylalkyl;
L is a bond or a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, and an optionally substituted alknylene; and
X is a counter anion.

As such, in another aspect, the present invention provides intermediate compounds of formula III:

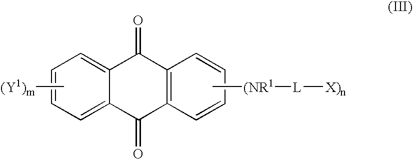

wherein:
each Y¹, which may be the same or different, is independently selected from a quaternary ammonium salt group and a substituent group;
R¹ is a member selected from the group consisting of hydrogen, an optionally substituted alkyl group, and an amino protecting group;
L is a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, and an optionally substituted alknylene;
X is a halide;
m is an integer from 0 to 4; and
n is an integer from 1 to 4. In a preferred embodiment, m=0 and n=1 or 2.
   Table 1 below and with reference with FIG. 1 illustrate an number of compounds of the invention.

TABLE 1
List of compounds

| Compound | R₁* | R₂* | R₃* |
|---|---|---|---|
| M-4 | H | H | H |
| M-8 | — | — | — |
| M-12 | — | — | — |
| M-16 | — | — | — |
| Di-4 | NH₂ | NHCH₂CH(OH)CH₂Cl | NHCH₂(OH)CH₂N⁺(CH₃)₂(CH₂)₃CH₃Cl⁻ |
| Di-8 | — | — | NHCH₂(OH)CH₂N + (CH₃)₂(CH₂)₇CH₃Cl⁻ |
| Di-12 | — | — | NHCH₂(OH)CH₂N + (CH₃)₂(CH₂)₁₁CH₃Cl⁻ |
| Di-16 | — | — | NHCH₂(OH)CH₂N⁺(CH₃)₂(CH₂)₁₅CH₃Cl⁻ |

(*See FIG. 1 for location of R₁, R₂ and R₃).

### V. Utility

Quaternary ammonium salts (QAS) are antimicrobial compounds. QAS inactivate microorganisms by disturbing their cytoplasmic membrane and have been widely used as surface disinfectants and antimicrobial finishing agents in textiles. See, for example, Kim et al., Textile Res. J.; 70:728 (2000); Kim et al., Textile Res. J.; 71:318 (2001); and Latlief et al., J. Pediatrics; 39:730 (1951). Meanwhile, anthraquinioid structures are excellent chromophores and have been widely used as dyes. Therefore, by incorporating both QAS and anthraquinone structures, compounds of formula I can be used simultaneously as dyes and functional finishing groups.

Accordingly, the polymers, fibers and textiles treated with a compound of formula I have microbiocidal activity against a broad spectrum of pathogenic microorganisms. For example, such polymers, textiles and fibers have microbiocidal activity against representative gram-positive (e.g, Staphylococcus aureus) and gram-negative bacteria (e.g., Escherichia coli).

Considering the antimicrobial and anti-static properties imparted to the finished textiles prepared according to the methods and compositions set forth herein, those of skill in the art will readily appreciate that such finished textiles can advantageously be used in the preparation of the following articles/garments: surgeon's gowns, caps, masks, surgical covers, patient drapes, carpeting, bedding materials, underwear, socks, uniforms, and the like. Those of skill in the art will also readily appreciate that the finished textiles of the present invention can advantageously be used for a variety of other purposes, such as in hotel-use towels, bedding materials, hygienic products, clothing to protect against pesticides and other toxic chemicals, and the like.

Numerous applications for the treated polymers of the present invention exist. For instance, the polymers can be used as microbiocidal protective clothing for personnel in the medical field as well as in related healthcare and hygiene areas.

In addition, the functional properties of the dyes of the present invention can be imparted to carpeting materials to create odor-free and germ-free carpets. Moreover, all germ-free environments, such as those required in biotechnology and in the pharmaceutical industry, can benefit from the use of the microbicidal polymers of the present invention to prevent any contamination from air, liquid, and/or solid media.

The treated polymers, textiles and fibers of the present invention are effective against a wide range of microorganisms including, but not limited to, bacteria, protozoa, fungi, viruses and algae. Moreover, the treated polymers described herein can be employed in a variety of disinfecting applications, such as water purification. They will be of importance in controlling microbiological contamination or growth of undesirable organisms in the medical and food industries. In addition, they can be used as preservatives and preventatives against microbiological contamination in paints, coatings, and on surfaces.

Numerous polymers can be modified using the compounds and methods of the present invention. Polymers suitable for use in the present invention include, but are not limited to, textiles. Suitable textiles include, without limitation, fibers from plants, polymers from animals, natural organic polymers, synthetic organic polymers, inorganic substances, and combinations thereof. In particular, the textile is selected from the group consisting of fibers from plants such as cellulose, cotton, linen, hemp, jute, wood pulp, paper, and ramie; polymers derived from animals such as wool, mohair, vicuna, and silk; manufactured fibers that are based on natural organic polymers such as rayon, lyocell, acetate, triacetate, and azlon; synthetic organic polymers such as nylon, polyester, a polyester/cellulose blend, acrylic, aramid, olefin, spandex, vinyon, vinyl, graphite, an aromatic polyamide; inorganic substances such as glass, a metallic material, and a ceramic material; and combinations thereof.

Various textiles are preferred to practice the invention. These include, but are not limited to, a fiber, a yarn, or a natural or synthetic fabric. Various fabrics include, but are not limited to, a nylon fabric, a polyester fabric, an acrylic fabric, NOMEX®, KEVLAR®, a triacetate fabric, an acetate fabric, a cotton fabric, a wool fabric, and a fabric that is made from a combination of two or more materials thereof. NOMEX® is made of an aromatic polyamide material and is available from DuPont (Wilmington, Del.). NOMEX® is used in fire fighting equipment.

As used herein, the term “acrylic fiber” refers to any manmade fiber derived from acrylic resins comprising a minimum of 85% acrylonitrile. Acrylic fiber is a manufactured fiber in which the fiber forming substance is any long-chain synthetic polymer comprising at least 85% by weight of acrylonitrile units (—CH₂—CH[CN]—)ₓ. Suitable acrylic fibers for use in the present invention include, but are not limited to, Orlon®, MicroSupreme®, Cresloft™, Creslan® Plus, BioFresh™, WeatherBloc™ (commercially available from Sterling Fibers, Inc.), Dralon™ (commercially available from Bayer Inc.), Acrilan®, Bounce-Back®, Duraspun®, Pil-Trol®, Sayelle®, Sno-Brite™, The Smart Yarns®, Wear-Dated®, Wintuk® (commercially available from Solutia Inc.), Acrilin® acrylic, Dolan®, Dralon®, Vinyon N®, Dynel®, Verel®, and SEF modacrylic®. Those of skill in the art will know of other manufactures and trade names of acrylic fibers suitable for use in the present invention.

Additional polymers suitable for use in the present invention include, but are not limited to, plastics, rubber, paint, a surface coating, an adhesive, and a combination of two or more thereof. Suitable plastics include, without limitation, polyethylene, polypropylene, polystyrene, polyvinylchloride, polyamideimide, polyethersulfone, polyarylsulfone, polyetherimide, polyarylate, polysulfone, polycarbonate, polyetherketone, polyetheretherketone, polytetrafluoroethylene, nylon-6,6, nylon-6,12, nylon-11, nylon-12, and acetal resin plastic materials, as well as combinations thereof.

The present invention also provides a polymer that is coated with the functionalized finishing dyes described above. As such, in another aspect, the present invention provides a polymer composition comprising:
(a) a polymer, wherein the polymer is a member selected from the group consisting of a textile, a plastic, rubber, paint, a surface coating, an adhesive, and a combination thereof; and
(b) a compound having the formula I.

Such polymers can be readily prepared using any one of conventional dyeing processes known to one skilled in the art. However, unlike conventional dyeing processes, methods of the present invention utilize the functional finishing dye described herein. In this manner, what is typically a two-step process of dyeing and finishing a polymer is achieved in a single process, thereby significantly reducing the overall cost and time.

In general, methods for treating a polymer are similar to other conventional dyeing processes. Thus, a polymer to be treated is immersed in a treating solution, typically an aqueous solution. The treating solution comprises a functional finishing dye of the present invention. The polymer is immersed in the treating solution for a period of time and under conditions appropriate to achieve a sufficient amount of polymer coating to produce a desired or favorable functional finishing dye-coated polymer, i.e., dye-treated polymer. The treated polymer is removed from the treating solution and dried.

As such, in yet another aspect, the present invention provides a method for simultaneously dyeing and finishing a polymer, the method comprising:
immersing the polymer in an aqueous treating solution which comprises a compound having a compound of formula I.

In one embodiment, the method further comprises removing excess aqueous treating solution from the polymer. For example, the excess aqueous treating solution can be removed with or without washing the polymer. In another embodiment, the method further comprises drying the article after removing excess aqueous treating solution to produce a dried polymer. In yet another embodiment, the aqueous treating solution further comprises a wetting agent.

The term “wetting agent” as used herein refers to a substance that increases the rate at which a liquid spreads across the polymer surface, i.e., it renders the polymer surface nonrepellent to a liquid. Examples of suitable wetting agents include, but are not limited to, Triton X-100 (Sigma Chemical Co., St. Louis, Mo.), SEQUAWET® (Sequa Chemical Inc., Chester, S.C.), and AMWET® (American Emulsions Co., Dalton, Ga.). Other wetting agents suitable for use in the present invention will be known to and used by those of skill in the art.

Other additives can also be present in the aqueous treating solution to impart additional characteristics to the polymer. Such additives include, but are not limited to, anti-static, softening, water-repellent, fire-resistant, soil-repellent, anti-UV, anti-chemical, and other antimicrobial agents, as well as a combination of two or more agents thereof. Other agents known to and used by those of skill in the art are also suitable additives. Examples of softeners which can be added to the aqueous treating solution include, but are not limited to, MYKON® and SEQUASOFT®, both of which are commercially available from Sequa Chemical Inc. (Chester, S.C.). Examples of water-repellent agents which can be added to the aqueous treating solution include, but are not limited to, SEQUAPEL® (Sequal Chemical Inc., Chester, S.C.), SCOTCHGARD (3M, St. Paul, Minn.), and other water-repellent finishing solutions known to and used by those of skill in the art.

Those of skill in the art will appreciate that the concentration of the various components of the treating solution can be varied widely depending on the particular components employed and the results desired. Typically, the functional finishing dye is present at a concentration of at least about 0.5% wt/vol. (g/mL). More typically, the functional finishing dye is present at a concentration ranging from about 0.1% wt/vol. to about 10% wt/vol., preferably at a concentration ranging from about 0.5% to about 5%, and more preferably at a concentration ranging from about 0.5% to about 2%. It will be readily apparent to those of skill in the art that higher functional finishing dye concentrations (e.g., 50% or more) can be employed, but such higher concentrations are not required to impart functionality to the polymer. Again, suitable functionality can be imparted using a functional finishing dye concentration as low as about 0.5%. The wetting agent is typically present at a concentration ranging from about 0.1% to about 3%, preferably at a concentration ranging from about 0.2% to about 1%. The pH of the treating solution will typically range from a pH of about 2 to about 6 and, preferably, from a pH of about 2.5 to about 4.5. In a particularly preferred embodiment, the pH of the treating solution is about 3.

As described above, the polymer is preferably a textile. The textile can be roving, yarn, or fabric regardless of whether spun, knit, or woven, or can be non-woven sheets or webs. Moreover, the textile can be made of cellulosic fibers, polyester fibers, or a blend of these. In addition, other polymer materials having reactive functional groups (e.g., —OH groups) can be used. Such polymer materials include, but are not limited to, polyvinyl alcohol (PVA), starches, and proteins. In wetting the textile in the finishing or treating bath, ordinary textile equipment and methods suitable for batchwise or continuous passage of roving, yarns, or fabrics through an aqueous solution can be used, at any speed permitting thorough and uniform wetting of the textile material.

The excess treating solution can be removed by ordinary mechanical methods such as by passing the treated polymer between squeeze rolls, by centrifugation, by draining, or by padding. In a preferred embodiment, the excess treating solution is removed by padding.

The treated polymer is then typically dried at a temperature ranging from about 50° C. to about 90° C., and more preferably at a temperature ranging from about 75° C. to about 85° C. for a period of time ranging from about 3 to about 8 minutes, preferably for about 5 minutes. Drying of treated polymer can be carried out using any ordinary means such as oven drying, line drying, or tumble drying in a mechanical clothes dryer.

The invention will be described in greater detail by way of specific examples. The following examples are offered for illustrative purposes, and are intended neither to limit or define the invention in any manner.

### VI. Examples

A. Materials and Instrumentation

1-Aminoanthraqinone (97%, Aldrich, Milwaukee, Mich.), 1,4-diaminoantraquinone (90%, Acros, Pittsburg, Pa.), epichlorohydrin (98%, Aldrich), N,N-dimethylbutylamine (99%, Acros), N,N-dimethyloutylamine (97%, Acros), N,N-dimethyldodecylamine (95%, Acros), N,N-dimethylhexadecylamine (95%, Acros) were used as received.

FT-IR spectra were taken on a Nicolet 6700 spectrometer (Thermo, USA) using KBr pellets. ¹H-NMR, ¹³C-NMR and COSY NMR spectra were recorded on a Bruker DRX 500 spectrometer (Bruker, USA). Electronic absorption spectra were recorded on a HITACHI U-2000 spectrophotometer (Hitachi, Japan) with a concentration of 100 ppm in distilled water solution.

B. Synthesis

1. Synthesis of M-4

0.01 mol of 1-aminoanthraquinone and 0.01 mol of epichlorohydrin in 20 mL acetic acid were kept for 9 hours at 95° C. During the first 6 hours, additional 0.01 mol of epichlorohydrin was added to the reacting system slowly. The reaction was monitored by TLC using hexane/ethyl acetate (2.5:1 volume ratio) as the eluent. Afterward, the reaction mixture was cooled to room temperature and stirred overnight. The product was precipitated with water and purified by recrystallization from methanol with a yield of 75%. The structure of the product was confirmed by NMR.

Then, 0.01 mol of the purified product, together with 0.1 mol tertiary amine, was dissolved in 15 mL n-propanol. The mixture was refluxed at 115° C. for 24 hours monitored by TLC in methanol. The suspension was precipitated by ethyl ether and then vacuum filtered. The crude product was recrystallized with alcohol-ether co-solvent (2:1 volume ratio). Yield: 95%. ¹H-NMR spectra data (DMSO): δ 9.872 (s, 1H, —NH—CH₂); 8.220˜8.206, 8.147˜8.133, 7.935˜7.907, 7.871˜7.843, 7.697˜7.665, 7.488˜7.474, 7.393˜7.375 (d, J=7.0 Hz, d, J=7.0 Hz, t, J=7.0 Hz, t, J=7.0 Hz, t, J=7.0 Hz, d, J=8.0 Hz, d, J=7.0 Hz, 7H, protons attached to C2, C3, C4, C5, C6, C7, C8); 6.165˜6.153 (d, J=9.0 Hz, 1H, CH—OH); 4.375 (m, J=6.0 Hz, 1H, CH—OH); 3.537˜3.363 (m, 6H, CH₂—CH (OH)—CH₂—N⁺(CH₃)₂—CH₂); 3.137˜3.125 (d, J=6.0 Hz, 6H, N⁺(CH₃)₂—CH₂—CH₂—CH₂—CH₃); 1.725˜1.602 (m, 2H, N⁺(CH₃)₂—CH₂—CH₂—CH₂—CH₃); 1.267˜1.256 (m, 2H, N⁺(CH₃)₂—CH₂—CH₂—CH₂—CH₃); 0.897˜0.868 (t, J=7.3 Hz, 3H, N⁺(CH₃)₂—CH₂—CH₂—CH₂—CH₃).

2. Synthesis of M-8

By using the same procedures of M-4 synthesis, M-8 was also prepared. Overall Yield: 71%. ¹H-NMR spectra data (DMSO): δ 9.857 (s, 1H, —NH—CH₂); 8.209˜8.194, 8.136˜8.121, 7.923˜7.895, 7.863˜7.835, 7.685˜7.653, 7.478˜7.464, 7.408˜7.391 (d, d, t, t, t, d, d, 7H, protons attached to C2, C3, C4, C5, C6, C7, C8); 6.210˜6.199 (d, 1H, CH—OH); 4.351 (m, 1H, CH—OH); 3.508˜3.362 (broad m, 6H, CH₂—CH(OH)—CH₂—N⁺(CH₃)₂—CH₂); 3.132 (s, 6H, N⁺(CH₃)₂—(CH₂)₇—H₃); 1.697˜1.549 (m, 2H, N⁺(CH₃)₂—(CH₂)₆—CH₂—H₃); 1.230˜1.167 (m, 2H, N⁺(CH₃)₂—CH₂—CH₂—(CH₂)₅—CH₃); 0.850˜0.823 (t, 3H, N⁺(CH₃)₂—(CH₂)₇CH₃).

3. Synthesis of M-12

M-12 was prepared following the same procedures. Yield: 69%. ¹H-NMR spectra data (DMSO): δ 9.860 (s, 1H, —NH—CH₂); 8.213˜8.198, 8.141˜8.127, 7.928˜7.900, 7.868˜7.840, 7.689˜7.658, 7.483˜7.469, 7.409˜7.392 (d, d, t, t, t, d, d, 7H, protons attached to C2, C3, C4, C5, C6, C7, C8); 6.199˜6.188 (d, 1H, CH—OH); 4.329 (m, 1H, CH—OH); 3.549˜3.354 (broad m, 6H, CH₂—CH (OH)—CH₂—N⁺(CH₃)₂—CH₂); 3.135 (s, 6H, N⁺(CH₃)₂—(CH₂)₁₁—CH₃); 1.701˜1.559 (m, 2H, N⁺(CH₃)₂—(CH₂)₁₀—CH₂—CH₃); centered at 1.194 (m, 2H, N⁺(CH₃)₂—CH₂—CH₂—(CH₂)₉—CH₃); 0.854˜0.827 (t, 3H, N⁺(CH₃)₂—(CH₂)₁₁CH₃).

4. Synthesis of M-16

M-16 was prepared by the same procedures. Yield: 70%. ¹H-NMR spectra data (DMSO): δ 9.860 (s, 1H, —NH—CH₂); 8.227˜8.212, 8.152˜8.136, 7.923˜7.893, 7.864˜7.835, 7.688˜7.657, 7.498˜7.483, 7.403˜7.386 (d, d, t, t, t, d, d, 7H, protons attached to C2, C3, C4, C5, C6, C7, C8); 6.154˜6.143 (d, 1H, CH—OH); 4.382 (m, 1H, CH—OH); 3.557˜3.345 (broad m, 6H, CH₂—CH(OH)—CH₂—N⁺(CH₃)₂—CH₂); 3.149 (s, 6H, N⁺(CH₃)₂—(CH₂)₁₅—CH₃); 1.729˜1.603 (m, 2H, N⁺(CH₃)₂—(CH₂)₁₄—CH₂—CH₃); centered at 1.228 (m, 2H, N⁺(CH₃)₂—CH₂—CH₂—(CH₂)₁₃—CH₃); 0.865—0.838 (t, 3H, N⁺(CH₃)₂—(CH₂)₁₅CH₃).

5. Synthesis of Di-4

0.01 mol of 1,4-diaminoanthraquinone and 0.10 mol of epichlorohydrin in 50 mL acetic acid were heated at 75° C. for one hour followed by precipitation with water. The crude product was purified by methanol. Yield: 78%. Quanterization of the intermediate was conducted by following the same procedures as mono-substituted series except using a molar ratio of 1/5 (intermediate/tertiary amine). A good yield of 95% was reached. ¹H-NMR spectra data (DMSO): δ 10.923 (s, 2H, v-NH—CH₂); 8.246˜8.229, 7.815˜7.797, 7.619 (m, m, s, 6H, protons attached to C2, C3, C4, C5, C6, C7, C8); 6.279˜6.269 (d, 2H, CH—OH); 4.349 (m, 2H, CH—OH); 3.588˜3.356 (broad m, 12H, CH₂—CH(OH)—CH₂—N⁺(CH₃)₂—CH₂); 3.150˜3.138 (d, 12H, N⁺(CH₃)₂—(CH₂)₃—CH₃); 1.728˜1.606 (m, 4H, N⁺(CH₃)₂—(CH₂)₂—CH₂—CH₃); 1.265˜1.252 (m, 4H, N⁺(CH₃)₂—CH₂—CH₂—CH₂—CH₃); 0.893˜0.869 (t, 6H, N⁺(CH₃)₂—(CH₂)₃—CH₃).

6. Synthesis of Di-8

Di 8 was prepared using the same procedure for preparation of Di-4. Yield: 74%. ¹H-NMR spectra data (DMSO): δ 10.913 (s, 2H, —NH—CH₂); 8.240, 7.806, 7.636 (m, m, s, 6H, protons attached to C2, C3, C4, C5, C6, C7, C8); 6.279 (d, 2H, CH—OH); 4.329 (m, 2H, CH—OH); 3.541˜3.357 (broad m, 12H, CH₂—CH(OH)—CH₂—N⁺(CH₃)₂—CH₂); 3.135 (s, 12H, N⁺(CH₃)₂—(CH₂)₇—CH₃); 1.702˜1.563 (m, 4H, N⁺(CH₃)₂—(CH₂)₆—CH₂—CH₃); 1.247˜1.172 (m, 4H, N⁺(CH₃)₂—CH₂—(CH₂)₅—CH₂—CH₃); 0.824˜0.811 (t, 6H, N⁺(CH₃)₂—(CH₂)₇CH₃).

7. Synthesis of Di-12

Di-12 was also prepared following the same procedure. Yield: 73%. ¹H-NMR spectra data (DMSO): δ 10.913 (s, 2H, —NH—CH₂); 8.249˜8.231, 7.809˜7.792, 7.640 (m, m, s, 6H, protons attached to C2, C3, C4, C5, C6, C7, C8); 6.279˜6.269 (d, 2H, CH—OH); 4.329 (m, 2H, CH—OH); 3.549˜3.354 (broad m, 12H, CH₂—-CH(OH)—CH₂—N⁺(CH₃)₂—CH₂); 3.135 (s, 12H, N⁺(CH₃)₂—(CH₂)₁₁—CH₃); 1.701˜1.559 (m, 4H, N⁺(CH₃)₂—(CH₂)₁₀—CH₂—CH3); centered at 1.194 (m, 4H, N⁺(CH₃)₂—CH₂—(CH₂)₉—CH₂—CH₃); 0.854˜0.827 (t, 6H, N⁺(CH₃)₂—(CH₂)₁₁CH₃).

8. Synthesis of Di-16

Di-16 was prepared according to the same method in synthesis of Di-4. Yield: 73%. ¹H-NMR spectra data (DMSO): δ 10.868˜10.845 (t, 2H, —NH—CH₂); 8.259˜8.241, 7.801˜7.783, 7.627 (m, m, s, 6H, protons attached to C2, C3, C4, C5, C6, C7, C8); 6.199˜6.189 (d, 2H, CH—OH); 4.359 (m, 2H, CH—OH); 3.602˜3.378 (broad m, 12H, CH₂—CH (OH)—CH₂—N⁺(CH₃)₂—CH₂); 3.154 (s, 12H, N⁺(CH₃)₂—(CH₂)₁₁—CH₃); 1.729˜1.608 (m, 4H, N⁺(CH₃)₂—(CH₂)₁₀—CH₂—CH₃); centered at 1.232 (m, 4H, N⁺(CH₃)₂—CH₂—(CH₂)₉—CH₂—CH₃); 0.866˜0.839 (t, 6H, N⁺(CH₃)₂—(CH₂)₁₁CH₃).

C. Antimicrobial Test

Antimicrobial activity of the agents in aqueous solution was evaluated by a minimum inhibitory concentration (MIC) procedure (Kaminski, J. J., Hyycke, N. M. et al., Pharm. Sci., 65(12):1737 (1976)). MIC refers to the lowest concentration of biocides that prohibit population and reproduction of microorganisms. In this method, 1 mL of an aqueous suspension containing 10⁶˜10⁷ colony-forming units (CFU)/mL of Staphylococcus aureus (S. aureus, ATCC #12600, Gram-positive) or Escherichia coli (E. coli, K-12, Gram-negative) were placed into 9 mL aqueous solutions containing different concentrations of the agents for a contact time of 24 hours. After the contact, a 100 μL aliquot of the resultant solution was serially diluted by sterilized distilled water to 10¹, 10², 10³, 10⁴ and 10⁵. 100 μL of the last four dilutions were placed onto a nutrient agar plate and incubated at 37° C. for 24 hours. The same procedure was applied to a distilled water solution without the antimicrobial agents as a control. In this paper, the reported MIC of the antimicrobial colorants is the minimum concentrations that can eliminate more than 4 log reductions of bacteria (1 log reduction is 90%, 2 log reduction is 99%, and so forth).

D. Stability Study

The stability of the antimicrobial colorants was qualitatively studied by using a UV-vis spectrophotometer under different experimental conditions. The tests were performed with antimicrobial colorant solutions at the concentration of 100 ppm in flasks. The colorants were sampled and the absorbance at the maximum absorption wavelength was tested before treatment as a reference. After visible light exposure in a conditioning room for over 30 days, or heating at boiling for 4 hours, or changing to different pH conditions (pH=4 and 10) for over 24 hours, the solutions were sampled, centrifuged, filtered and tested by UV. The new UV-vis spectra were taken and compared with the control.

E. Structure Characterization

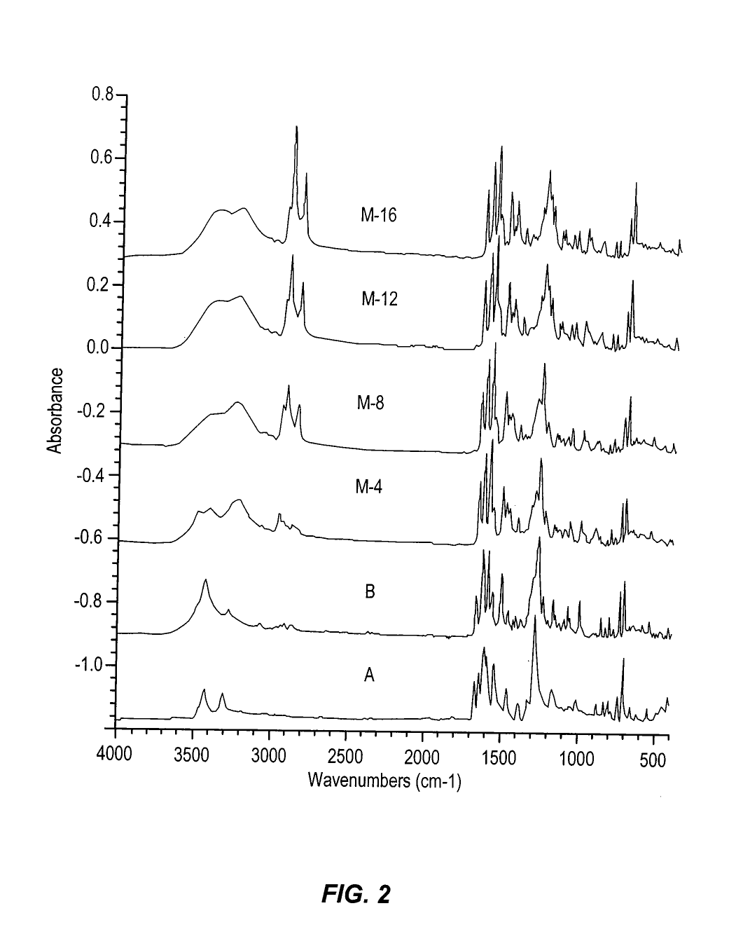

FT-IR spectra of the mono-substituted dyes (“M”) are shown in FIG. 2. The infrared absorbance bands at 3419, 3304, 1666 cm⁻¹ in 1-aminoanthrquinone (A) were ascribed to —NH₂ and C═O stretching bands of the aminoanthraquinone structures, which is in agreement with the literature data (Silverstein, R. M. and Webster, F. X., Spectrometric identification of organic compounds, John Wiley & Sons (New York, N.Y. 1998)). In the spectrum of the intermediate (B), two stretching peaks representing primary amine in 1-aminoanthrquinone disappeared, proving the substitution of epichlorohydrin occurred on —NH₂. The intermediate (B) and all the mono-substituted colorants show one broad band in the region of 3200˜3500 cm⁻¹, which was referenced as the combination stretching of secondary amine —NH and hydroxyl group —OH. It is also worth of noting that with the increasing of QAS alkyl chain length, the intensities of the alkyl absorption bands (2800˜3000 cm⁻¹) rose accordingly. Similar phenomena can be observed in the FT-IR spectra of the di-substituted colorants.

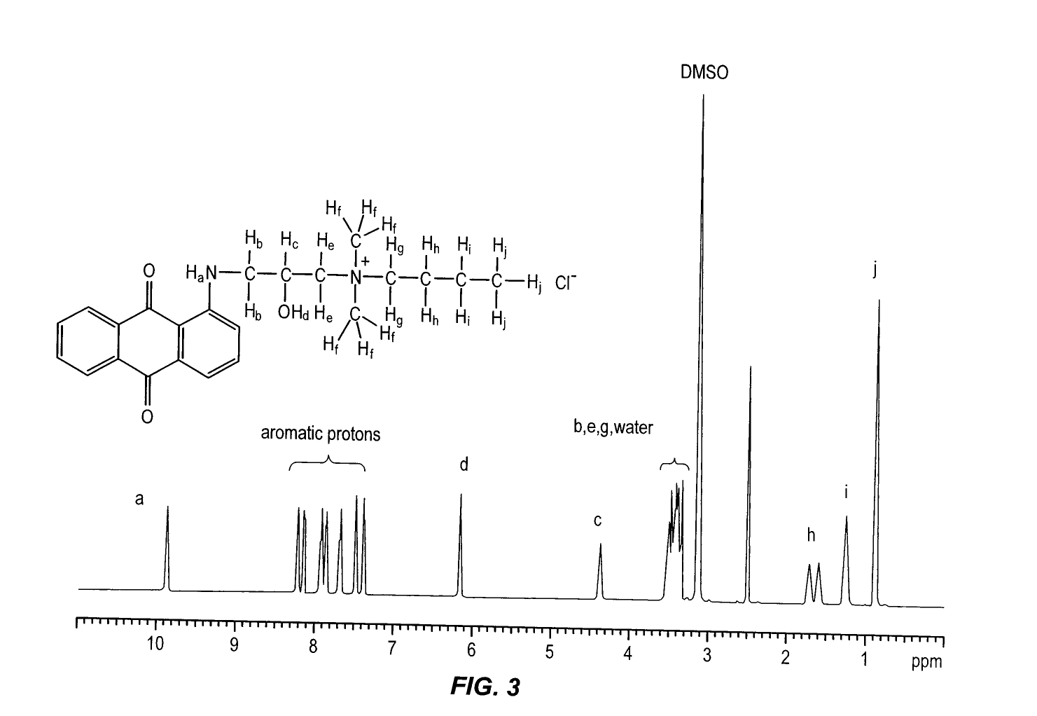

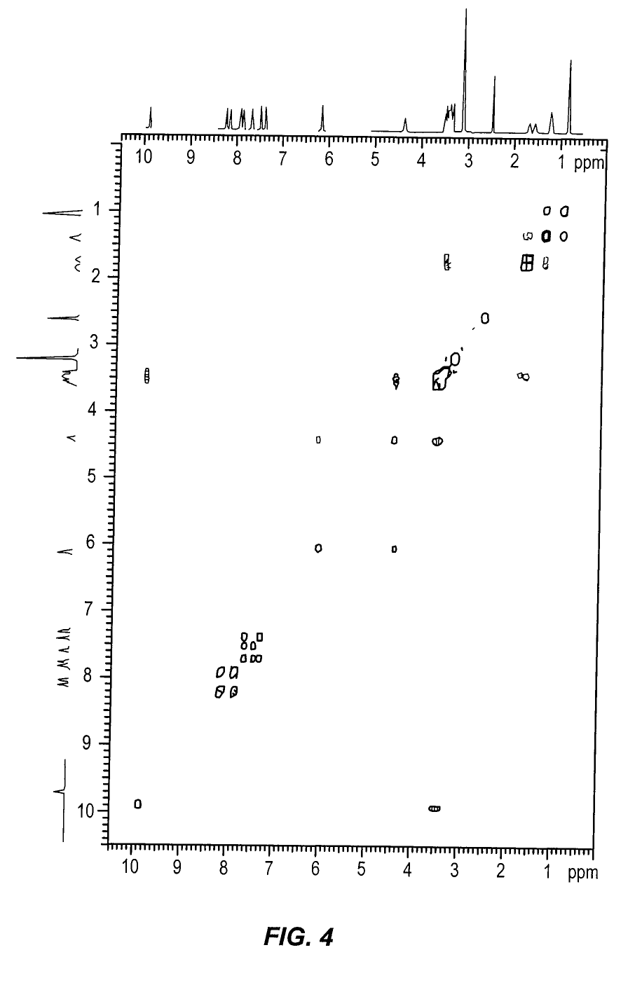

The chemical structures of QAS were confirmed by ¹H NMR and ¹H—¹H COSY spectra (FIG. 3 and FIG. 4, respectively). Taking M-4 as an example, the peak at 9.872 ppm is attributed to amino proton (Hₐ), the signal at 4.375 ppm is assigned to the proton on the carbon next to —OH (H_{d}). The proton in —OH showed chemical shifts to around 6.165˜6.153 ppm. The coupling between Hₐ and H_{b} and other ¹H—¹H coupling can be observed from FIG. 4. By comparing the ¹H NMR spectra of M-4, M-8 and M-12, we can see that the intensity of alkyl groups (1.1˜1.3 ppm) is going up significantly with the increase of alkyl chain length. The above analysis suggests that the antimicrobial colorants follow the proposed synthesis routes.

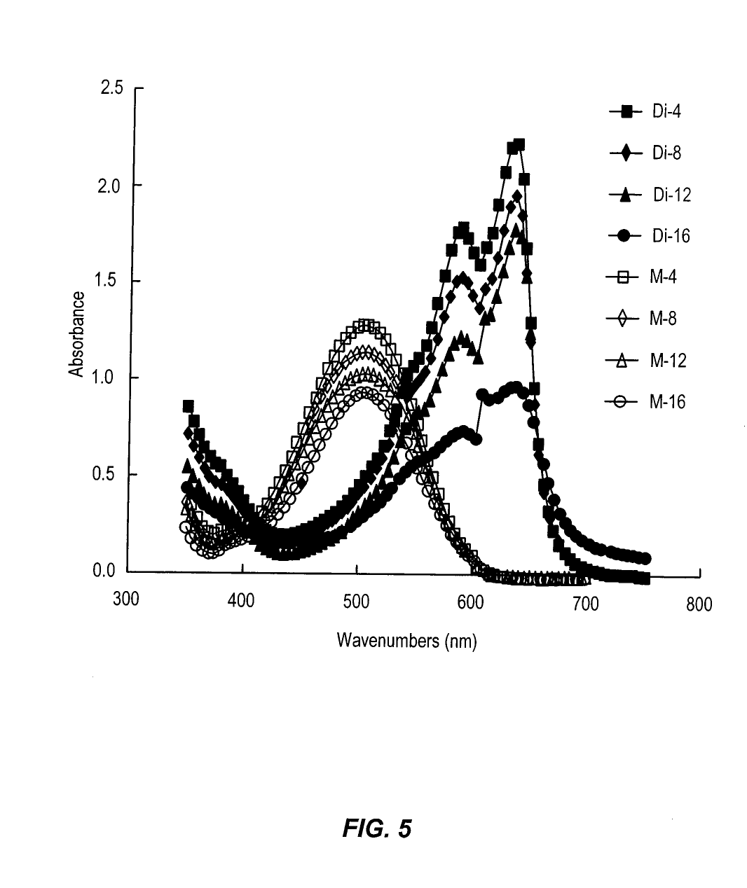

The UV-vis spectra of the synthesized QAS were measured to identify the absorbance-structure relationship and are revealed in FIG. 5. The di-substituted anthraquinone dyes show greater bathochromicity compared with the mono-substituted series as a result of the increasing of p-π conjugation between the aromatic ring and amino groups. The additional auxochromic groups such as —NH, —OH and Cl in the di-substituted series further enhance this effect.

The mono-substituted QAS show the same maximum absorption wavelength (λₘₐₓ) at 503 nm, while the di-substituted series present a bathochromic shift from 628 nm to 631.5 nm. This phenomenon can be interpreted by two factors: Steric hindrance and possible intramolecular hydrogen bonding. The longer alkane chains in the di-substituted QAS render relatively greater steric hindrance effect, which induces a red shift. Possible intramolecular hydrogen bonding within the dye molecules may also leads to bathochromic shift by holding the groups in a planar configuration (Ma, M., Sun, Y. et al, Dyes and Pigments, 58(1):27 (2003)).

F. Antimicrobial Assessment

Antimicrobial properties of the antimicrobial colorants in aqueous solutions were measured by the MIC procedure. The MIC of the antimicrobial colorants against both E. coli and S. aureus are listed in Table 2.

TABLE 2
MIC of cationic colorants

Hydrocarbon chain length

| | | | | |
|---|---|---|---|---|
| (ppm) | 4 | 8 | 12 | 16 |

| | | | | | |
|---|---|---|---|---|---|
| Mono | E. coli | 200 | 5 | 4 | 60 |
| | S. aureus | 200 | 5 | 4 | 60 |
| Di | E. coli | 200 | 5 | 4 | 60 |
| | S. aureus | 200 | 5 | 4 | 60 |

Note:
10⁷~10⁸ CFU/mL, contact time: 24 hr

The results indicate that the colorants can inactivate both Gram-negative and Gram-positive bacteria effectively. Generally speaking, Gram-negative bacteria are more resistant to QAS due to the thick lipopolysaccharide wall structure. However, no difference in antimicrobial efficacy was detected on these two microorganisms from these two series of cationic colorants under this testing condition. The MIC values indicated that all eight colorants could destroy bacteria completely at quite low concentrations, depending on the hydrocarbon chain lengths of them. The colorants with dodecyl group showed the most powerful function. Not surprisingly, the antimicrobial efficacy of the colorants bearing butyl group are relatively low due to short alkyl chain length. In addition, the M series and Di series with the same chain length show no distinct biocidal activities using this test method even though Di series compounds possess two QAS structures in one molecule.

To better study the biocidal rate of these colorants, the antimicrobial efficacy of the colorants in terms of log reduction is assessed against E. Coli under different contact time ranging from 15 minutes to 24 hours. As shown in Table 3, Di-12, M-12 and Di-8 can kill the bacteria completely within 15 minutes.

TABLE 3
Time dependence of the antimicrobial efficacy of the colorants

| | |
|---|---|
| Contact | Antimicrobial Efficacy (log reduction) |

| Time (hr) | M-4 | M-8 | M-12 | Di-4 | Di-8 | Di-12 |
|---|---|---|---|---|---|---|
| 0.25 | 0 | 0 | >4 | 0 | >4 | >4 |
| 0.5 | 0 | 0 | >4 | 0 | >4 | >4 |
| 1 | 0 | 0 | >4 | 0 | >4 | >4 |
| 2 | 0 | 0.57 | >4 | 0 | >4 | >4 |
| 4 | 0 | 1.5 | >4 | 0 | >4 | >4 |
| 8 | 0 | 2.4 | >4 | 0 | >4 | >4 |
| 16 | 0 | 4 | >4 | 0 | >4 | >4 |
| 24 | 0 | >4 | >4 | 0 | >4 | >4 |

Note:
At the concentration of 10 ppm

Interestingly, the log reduction of E. coli increases gradually at the presence of M-12. This phenomenon can be explained by the nature of the growth/death of bacteria. Microbial death is logarithmic or exponential, just like growth.

Next, the antimicrobial efficacy of the colorants is further challenged by reducing the contact time down to 1 minute at the concentration of 10 ppm. The results are illustrated in Table 4. As can been seen, Di-12, M-12 and Di-8 are still quite effective and eliminate both E. coli and S. aureus totally. The colorants with butyl and hexadecyl groups show zero reduction, which is very consistent with previous tests.

TABLE 4
The antimicrobial efficacy of the colorants against Gram-positive
and Gram-negative bacteria

| | Antimicrobial efficacy (Log reduction) | | | | | | | |
|---|---|---|---|---|---|---|---|---|
| Bacteria | M-4 | M-8 | M-12 | M-16 | Di-4 | Di-8 | Di-12 | Di-16 |
| S. aureus | 0 | 0 | >4 | 0 | 0 | 2 | >4 | 0 |
| E. Coli. | 0 | 0 | >4 | 0 | 0 | 2 | >4 | 0 |

The best performance of the more effective colorants Di-12, M-12 and Di-8 is assessed against E. Coli at MIC (5 ppm) at the contact time of 1 minute as listed in Table 5. It turns out that Di-12 and M-12 show total kill; while Di-8 inactivates the bacteria by 1 log reduction.

TABLE 5
The antimicrobial activities of high performance
antimicrobial colorants at 5 ppm

| Concentration | Log reduction | | |
|---|---|---|---|
| (ppm) | Di-8 | M-12 | Di-12 |
| 5 | 1 | 3 | >5 |

Note:
E. coli concentration: 10⁷~10⁸ CFU/ml

The colorants Di-12 and M-12 are compared with several traditional QAS as disinfectants: Cetyltrimethyl ammonium bromide (CTAB), N-cetylpyridinium chloride (CPC) and Benzyldimethyl-hexadecylammonium chloride (Benzalkonium chloride). As shown in Table 6, Di-12 and M-12 are both more efficient in biocidal activity than the other three bactericides.

TABLE 6
Comparison with other antimicrobial agents

| Concentration | Antimicrobial Efficacy (log reduction) | | | | |
|---|---|---|---|---|---|
| (ppm) | M-12 | Di-12 | CTAB | CPC | Benzalkonium chloride |
| 10 | 3 | >5 | 0 | 0 | 2 |

Note:
E. coli concentration: 10⁷~10⁸ CFU/ml; M-12 is 14 ppm, which is equivalent to Di-12

G. Stability of Cationic Colorant Solutions

The stability of the antimicrobial colorants is of great importance because they are mostly applied in aqueous solutions as biocides or dyes. All stability tests were conducted at a concentration of 100 ppm. UV-vis absorbance of the colorant solutions was observed to examine their stability under different conditions. The UV-vis spectra before and after light exposure showed no appreciable difference, indicating excellent stability of the colorants under visible light. Compared with triphenylmethane dyes that could degrade in half an hour under unfiltered daylight (Alderman, D. J., J Fish Dis., 8:289 (1985); Allen, N. S., Dyes and Pigments, 1(1):49 (1980)), this colorant showed outstanding stability against daylight.

In practical applications, these colorants could be used under either acidic or basic conditions, particularly in coloration of acrylics, nylon and wool. For example, acidic dye bath is preferred for dyeing wool fabrics. Thus, the stability of the colorants in low or high pH solution is more important for textile applications. In fact, the colorants prepared previously exhibited very disappointing hydrolytic stability, particularly under alkaline conditions (Ma, M. and Sun, G., Dyes and Pigments, 63(1):39 (2004)). The low stability of those colorants was caused by hydrolysis of an amide linkage between QAS and aminoanthraquinone. Thus, in the new colorants the amide bond is replaced by alkyl amino structures that are resistant to both acidic and alkaline hydrolysis. The colorant solutions were adjusted to pH 4 and pH 10 by using pH buffers at the concentration of 100 ppm for 24 hours. UV-vis spectra of the solutions were compared with the solution prepared at neutral. No any dramatic shift of both wavelengths and absorbance was observed, indicating that the colorants were stable under pH conditions. The results strongly supported the expectation of the new structures.

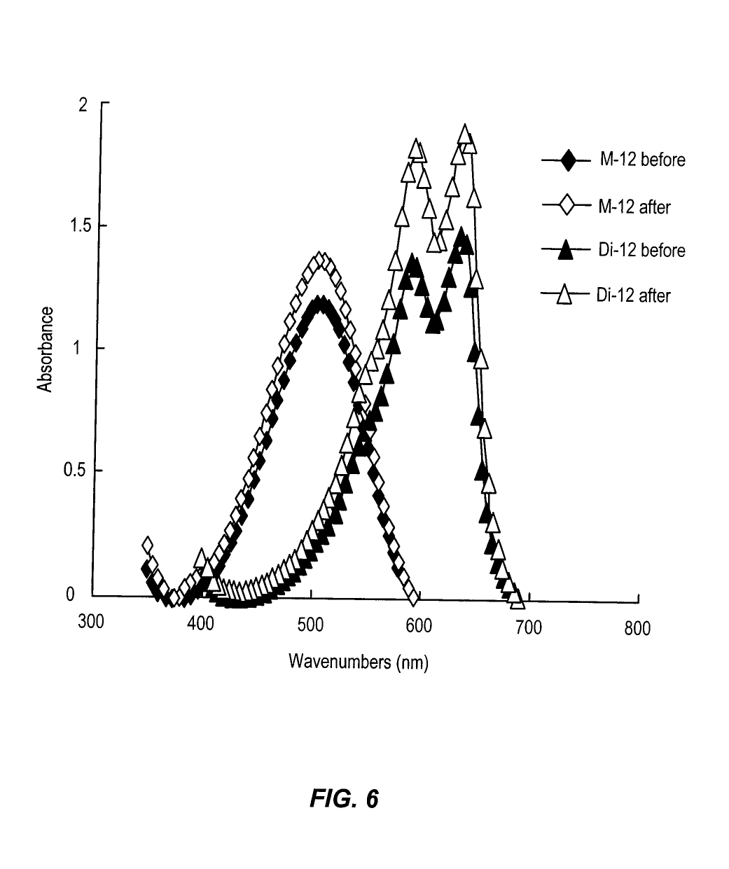

Hydrolysis of the structures could be catalyzed by elevated temperature. So the colorant solutions should be able to stand long duration of heating in dyeing process. In this test, the colorants at the concentration of 100 ppm were heated at 100° C. for 4 hours in aqueous solutions. UV-vis spectra of M-12 and Di-12 before and after heating are shown in FIG. 6, the wavelengths of the two colorants showed negligible change (within system error); the slight increases in absorbance are believed to be caused by the loss of water when heating. This is another significant improvement compared with the earlier work (Ma, M. and Sun, G., Dyes and Pigments, 63(1):39 (2004)).

While the invention has been described by way of example and in terms of the specific embodiments, it is to be understood that examples and embodiments described herein are for illustrative purposes only and the invention is not limited to the disclosed embodiments. It is intended to cover various modifications and similar arrangements as would be apparent to those skilled in the art. Therefore, the scope of the appended claims should be accorded the broadest interpretation so as to encompass all such modifications and similar arrangements. All publications, patents, and patent applications cited herein are hereby incorporated by reference in their entirety for all purposes.

What is claimed is:

1. A compound having formula I: 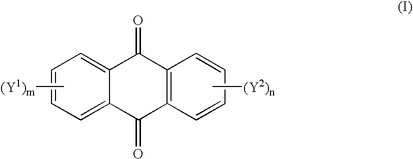
wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

2. The compound of claim 1, wherein said quaternary ammonium salt group has formula Ia:
—N(R¹)-L-N⁺(R²)(R³)(R⁴).X⁻, (IA)
wherein:
R¹ is a member selected from the group consisting of hydrogen, an optionally substituted alkyl group, and an amino protecting group;
L is a bond or a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, an optionally substituted and an optionally substituted alknylene
each of R², R³, and R⁴ is independently selected from the group consisting of hydrogen, an optionally substituted alkyl, an optionally substituted aryl, an optionally substituted aralkyl, an optionally substituted cycloalkyl, and an optionally substituted cycloalkylalkyl; and
X is a counter anion.

3. The compound of claim 2, wherein said linker is an optionally substituted C₁₋₁₂alkylene or an optionally substituted alkylene optionally interrupted with a heteroatom.

4. The compound of claim 2, wherein said linker is a substituted alkylene.

5. The compound of claim 4, wherein said compound has formula Ib: 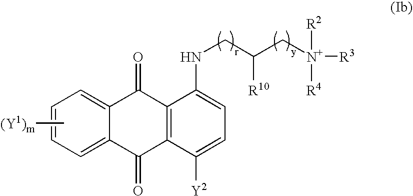
wherein:
Y² is —H or —N(R¹)-L-N⁺(R²)(R³)(R⁴).X⁻;
R² and R³ are each independently selected from an optionally substituted C₁-C₄ alkyl groups;
R⁴ is an optionally substituted C₄-C₁₈ alkyl group;
R¹⁰ is hydrogen, hydroxyl, an optionally substituted alkyl, an optionally substituted alkoxy, an optionally amino, an optionally substituted aryl, and an optionally substituted thiol.
r and y are each independently 0 to 4; and
X is a counter anion.

6. The compound of claim 5, wherein
Y² is —H;
m is 0;
R¹⁰ is hydroxyl;
r and y are each 1; and
X is a counter anion.

7. A compound of formula III: 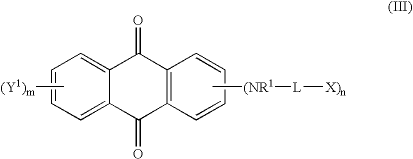
wherein:
Y¹ is independently selected from a quaternary ammonium salt group and a substituent group;
R¹ is a member selected from the group consisting of hydrogen, an optionally substituted alkyl group, and an amino protecting group;
L is a bond or a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, and an optionally substituted alknylene;
X is a halide;
m is an integer from 0 to 4; and
n is an integer from 1 to 4.

8. An antimicrobial composition, said composition comprising:
(a) a polymer, wherein said polymer is a member selected from the group consisting of a textile, a plastic, rubber, paint, a surface coating, an adhesive, and a combination thereof; and
(b) a compound having formula I: 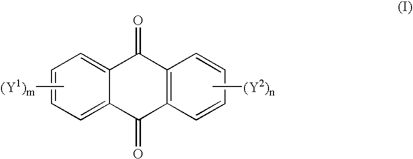
wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

9. The composition of claim 8, wherein said polymer is a textile.

10. The composition of claim 9, wherein said textile is selected from the group consisting of a fiber from a plant, a polymer from an animal, a natural organic polymer, a synthetic organic polymer, an inorganic substance, and a combination thereof.

11. The composition of claim 10, wherein said textile is selected from the group consisting of cellulose, cotton, linen, hemp, jute, ramie, wool, mohair, vicuna, silk, rayon, lyocell, acetate, triacetate, nylon, polyester, a polyester/cellulose blend, acrylic, azlon, aramid, olefin, spandex, vinyon, vinyl, graphite, an aromatic polyamide, glass, a metallic material, a ceramic material, and a combination thereof.

12. The composition of claim 8, wherein said polymer is a plastic.

13. The composition of claim 12, wherein said plastic is selected from the group consisting of polyethylene, polypropylene, polystyrene, and polyvinylchloride polyamideimide, polyethersulfone, polyarylsulfone, polyetherimide, polyarylate, polysulfone, polycarbonate, polyetherketone, polyetheretherketone, polytetrafluoroethylene, nylon-6,6, nylon-6,12, nylon-11, nylon-12, acetal resin, polypropylene, polyethylene, and a combination thereof.

14. A method for simultaneously dyeing and finishing a polymer, said method comprising:
immersing said polymer in an aqueous treating solution which comprises a compound having formula I: 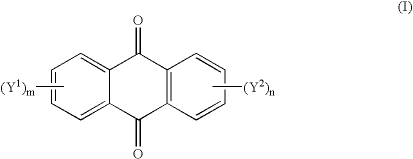
wherein:
each Y¹, which may be the same or different, is independently selected from a quaternary ammonium salt group and a substituent group;
each Y², which may be the same or different, is independently selected from a quaternary ammonium salt group and a substituent group;
m is an integer from 0 to 4; and
n is an integer from 1 to 4.

15. The method of claim 14, further comprising removing excess aqueous treating solution from said polymer.

16. The method of claim 15, further comprising drying said article after removing excess aqueous treating solution to produce a dried polymer.

17. The method of claim 14, wherein said aqueous treating solution further comprises a wetting agent.

18. The method of claim 14, wherein said polymer is a textile.

19. The method of claim 18, wherein said textile is selected from the group consisting of a fiber from a plant, a polymer from an animal, a natural organic polymer, a synthetic organic polymer, an inorganic substance, and a combination thereof.

20. The method of claim 19, wherein said textile is selected from the group consisting of cellulose, cotton, linen, hemp, jute, ramie, wool, mohair, vicuna, silk, rayon, lyocell, acetate, triacetate, nylon, polyester, a polyester/cellulose blend, acrylic, azlon, aramid, olefin, spandex, vinyon, vinyl, graphite, an aromatic polyamide, glass, a metallic material, a ceramic material, and a combination thereof.

21. The method of claim 14, wherein said polymer is a plastic.

22. The method of claim 21, wherein said plastic is selected from the group consisting of polyethylene, polypropylene, polystyrene, and polyvinylchloride polyamideimide, polyethersulfone, polyarylsulfone, polyetherimide, polyarylate, polysulfone, polycarbonate, polyetherketone, polyetheretherketone, polytetrafluoroethylene, nylon-6,6, nylon-6,12, nylon-11, nylon-12, acetal resin, polypropylene, polyethylene, and a combination thereof.

23. A method for preparing a colorant, said method comprising:
contacting a compound of formula II: 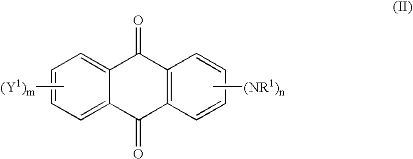
with a compound of formula E-L-X under conditions sufficient to form a compound of formula III: 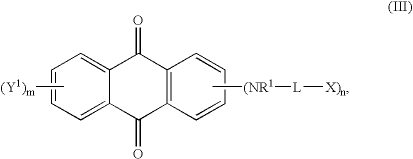
wherein:
each Y¹, which may be the same or different, is independently selected from a quaternary ammonium salt group and a substituent group;
R¹ is a member selected from the group consisting of hydrogen, an optionally substituted alkyl group, and an amino protecting group;
E is an electrophic group or a carbon capable of reacting with an amino group to form a nitrogen-carbon bond;
L is a bond or a linker selected from the group consisting of alkylene, heteroalkylene, cycloalkylene, cycloalkylalkyllene, arakylene, arylene, heteroarylene, heteroaralkylene, alkenylene, substituted alkylene and alknylene;
X is a halide;
m is an integer from 0 to 4; and
n is an integer from 1 to 4.

24. A method for preparing an antimicrobial colorant, said method comprising:
contacting a compound of formula III: 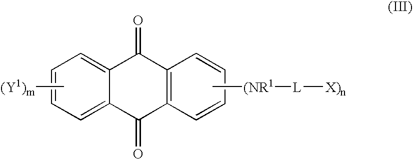
with a tertiary amine having the formula: N(R²)(R³)(R⁴) under conditions sufficient to form a quaternary ammonium salt of formula I,
wherein:
R¹ is a member selected from the group consisting of hydrogen, an optionally substituted alkyl group, and an amino protecting group;
each of R², R³, and R⁴ is independently selected from the group consisting of hydrogen, an optionally substituted alkyl, an optionally substituted aryl, an optionally substituted aralkyl, an optionally substituted cycloalkyl, and cycloalkylalkyl;
L is a bond or a linker selected from the group consisting of an optionally substituted alkylene, an optionally substituted heteroalkylene, an optionally substituted cycloalkylene, an optionally substituted cycloalkylalkylene, an optionally substituted arakylene, an optionally substituted arylene, an optionally substituted heteroarylene, an optionally substituted heteroaralkylene, an optionally substituted alkenylene, and an optionally substituted alknylene; and
X is a counter anion.

25. A method for making an antimicrobial article, said method comprising: contacting a compound of claim 1, with an article to thereby make an antimicrobial article.
